(19) United States
(12) Patent Application Publication
(10) Pub. No.: US 2011/0180351 A1
(43) Pub. Date: Jul. 28, 2011

(54) TREESTAND WITH FOLDING LEG SUPPORT AND METHOD OF MAKING THEREOF

(76) Inventor: Mark R. Cama, Johnston, RI (US)

(21) Appl. No.: 13/081,979

(22) Filed: Apr. 7, 2011

Related U.S. Application Data
(62) Division of application No. 12/251,011, filed on Oct. 14, 2008.
(60) Provisional application No. 60/979,579, filed on Oct. 12, 2007.

(51) Int. Cl. A01M 31/02; E04G 5/06; E04G 7/00

(52) U.S. Cl. 182/222

(57) ABSTRACT

A method of manufacturing a treestand platform is disclosed. First, a plurality of treestand components is provided. The treestand components are assembled together to form a treestand platform. The treestand platform is then brazed to bond the treestand components permanently together to form a brazed treestand platform. The treestand platform will generally include a frame having a top surface and a bottom surface and interior portion. A number of rail members are configured and arranged to form a grid pattern with a top edge and bottom edge. The rail members secured within the interior portion of the frame. A top plate secured the frame and the top edge of the plurality of rail members and a bottom plate secured to the frame and the bottom edge of the plurality of rail members.

### CROSS-REFERENCE TO RELATED APPLICATION

The present patent document is a division of U.S. patent application Ser. No. 12/251,011, filed on Oct. 14, 2008, which claims priority to earlier filed U.S. Provisional Patent Application Ser. No. 60/979,579, filed Oct. 12, 2007, the entire contents of which are incorporated herein by reference.

### BACKGROUND OF THE INVENTION

1. Field of the Invention

The present invention relates generally to portable treestands used by hunters and more particularly to the structure and method of making a treestand platform with reduced weight and improved strength and carrying capacity.

2. Background of the Related Art

Portable treestands for hunting have been used for many years. Such treestands are available in an extremely wide variety of types, providing a myriad of sizes, shapes, materials of construction, mounting mechanisms and other features. Generally speaking, treestands come in four main varieties: tripod stands, ladders stands, hang-on stands, and climbing treestands. Tripod stands do not require a tree in order to be erected. U.S. Pat. No. 5,009,283, issued to Prejean, is an example of a prior art tripod stand. Ladder stands incorporate a ladder with a platform attached to top end of the ladder. Ladder stands are leaned against a tree and secure with a straps and chains. U.S. Pat. Nos. 3,630,314, issued to Bamburg, and 3,057,431, issued to George, are examples of prior art ladder stands. Hang-on stands are platforms that are strapped to the trunk a tree. Because hang-on stands do not include a ladder, the hunter must bring some other means to climb a tree to install the tree stand, such as tree spikes, for instance. U.S. Pat. No. 3,065,821, issued to Hundley, Jr., is an example of a hang-on tree stand. Lastly, climbing treestands are platforms configured to allow the hunter to install the treestand without the aid of a ladder by shimmying up the tree using the treestand itself as a climbing aid. U.S. Pat. Nos. 3,460,649, issued to Baker, and 3,485,320, issued to Jones, are examples of prior art climbing treestands.

In the case of portable treestands, key among the important features to be considered by a hunter in choosing a portable treestand are safety, weight, comfort, strength, durability, and simplicity of construction and use. The considerations of safety and weight are often conflicting because adequate strength frequently requires the use of heavier and stronger structural members. Lightweight structural materials are, therefore, used almost exclusively in the construction of treestands. To balance the considerations of strength, weight and cost, structural aluminum has been the material of choice. As a result, the majority of treestands on the market today utilize some type of tubular aluminum supporting structure for the main supporting platform of the treestand. The tubular aluminum supporting structure may include cross members which are closely enough spaced to provide the platform on which the hunter may stand directly. More often, however, the structural aluminum framework generally defines the outer perimeter of the platform and includes a few intermediate cross members. The supporting framework is covered with a thin rigid layer of floor material of any of several types, including sheets of wood or plastic and expanded metal grids. Typically, portable treestands weigh between 12 and 15 lbs. and are rated to support up to 350 lbs safely.

In each of the prior art treestand platforms broadly included in the various types described above, the platform is fabricated from a plurality of components using a variety of fastening techniques, including welding, rivets, screws and bolts. Even in those treestand platform constructions in which the structural aluminum members are closely spaced so that a separate floor covering is not required, a large amount of welding is required in the fabrication process. Where a floor cover or plate is also required, additional welding or the use of other types of fasteners must be undertaken. The inventor is not aware of any prior art treestand in which the platform does not require a series of tedious, time consuming and expensive fabrication steps.

It is also well known that welds occasionally break and that the welding process itself may have an adverse affect on the strength or structural integrity of the members as a result of high welding heat. The use of mechanical fasteners in the fabrication of a platform creates joints which inherently are not completely rigid and as a result may move and squeak or create other noises. Skilled hunters are extremely sensitive to any equipment that is unnecessarily noisy. Fasteners and fastener joints also present the potential for catching clothing or the like which is both annoying and potentially dangerous.

Thus, despite the extremely wide variety of treestand platforms disclosed in the prior art and on the market today, all are subject to the same problems and deficiencies in construction, operation and use described above. It would be most desirable, therefore, to have a treestand including a platform which is of simple construction, does not require welded fabrication or the use of fasteners, and yet is strong and light weight. In addition, the platform should be readily adaptable for use in both climbing and non-climbing stand constructions. Moreover, it would be desirable to have a portable treestand construction that weighed under 12 lbs, yet could still safely hold at least 350 lbs.

Because hunters may spend hours on end in a treestand, it is important that the hunter is comfortable. Many treestands include some sort of seat on the treestand platform. However, many portable treestands lack a seat or have a tiny seat in order to make them as lightweight as possible. Portable treestands that lack a seat are typically not intended to be sat on by a hunter. If the hunter sits on these platforms, however, the hunter's lower legs and feet dangle. If the hunter's lower legs and feet are allowed to dangle, however, the hunter's circulation to his feet becomes impaired because of the pressure exerted behind the knees of the hunter's legs by the mere weight of his lower legs and feet and boots restricts blood flow. This can result in the hunter's lower legs and feet “falling asleep” and becoming cold. Consequently, the hunter can become fatigued and risks succumbing to the effects of exposure. Accordingly, it is desirable to provide some structure to support the hunter's feet and prevent loss of circulation to the hunter's lower legs and feet, yet is lightweight for portable treestands.

### SUMMARY OF THE INVENTION

The treestand and method of making a treestand described herein solves the problems of the prior art by providing a treestand platform having a tubular frame surrounding a lattice or web of intersecting rail members. A top plate and a bottom plate cover the tubular frame and lattice and the entire platform is brazed or adhered together forming a sturdy treestand platform. The resulting platform, when further configured into a portable treestand, can weigh under 4½ lbs. and hold weights greater than 700 lbs. The platform may also be used in other treestand configurations, such as ladderstands and tripod stands. The treestand platform may further include a folding leg support to prevent fatigue and reduce restriction of blood circulation to the hunter's legs and feet, which enables the treestand platform to be comfortably used as a seat by the hunter.

### BRIEF DESCRIPTION OF THE DRAWINGS

These and other features, aspects, and advantages of the treestand will become better understood with reference to the following description, appended claims, and accompanying drawings where:

FIG. 1A shows a perspective view of a tree stand platform with a folding leg support in the folded position constructed in accordance with method of the present invention;

FIG. 1B and a perspective view of a tree stand platform with a folding leg support in the unfolded position constructed in accordance with method of the present invention;

FIG. 2 shows a side view of the treestand platform and folding leg support,

FIG. 3 shows a cross-section view of through line A-A of FIG. 2;

FIG. 4 shows a close-up view of inset A of FIG. 1A;

FIG. 5 shows an assembled and an exploded view of the treestand platform of the present invention;

FIG. 6 shows a top view of the top plate of the treestand platform of the present invention, it being understood the that bottom plate is identical thereto; and

FIG. 7 shows a side view of a lattice rail element used to construct the treestand platform of the present invention.

### DESCRIPTION OF THE PREFERRED EMBODIMENT

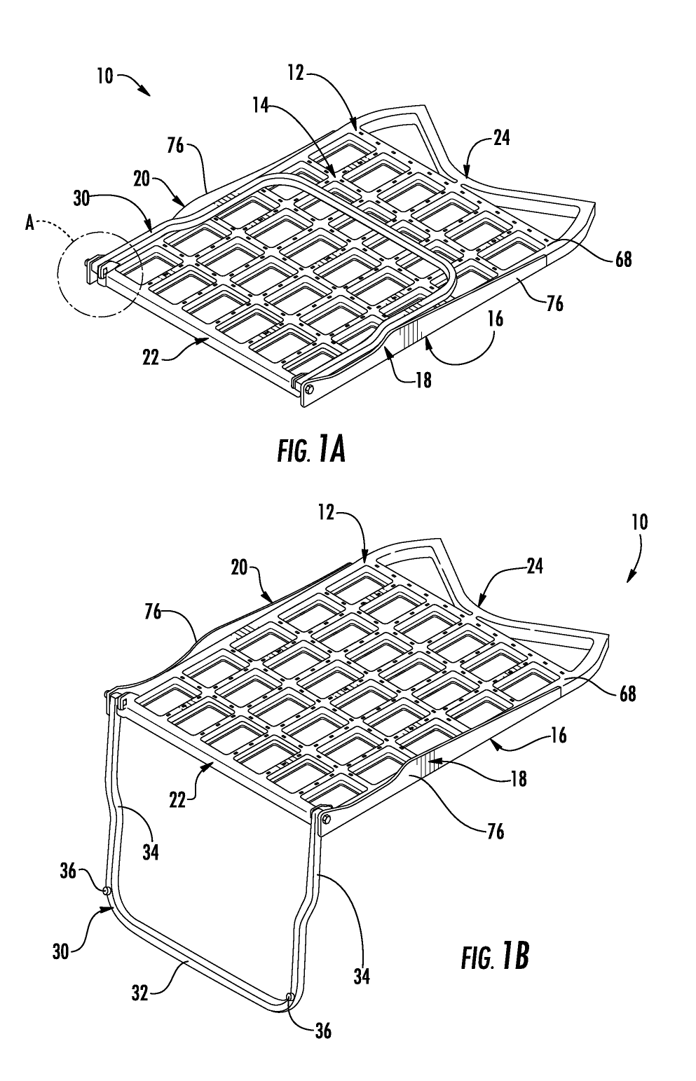

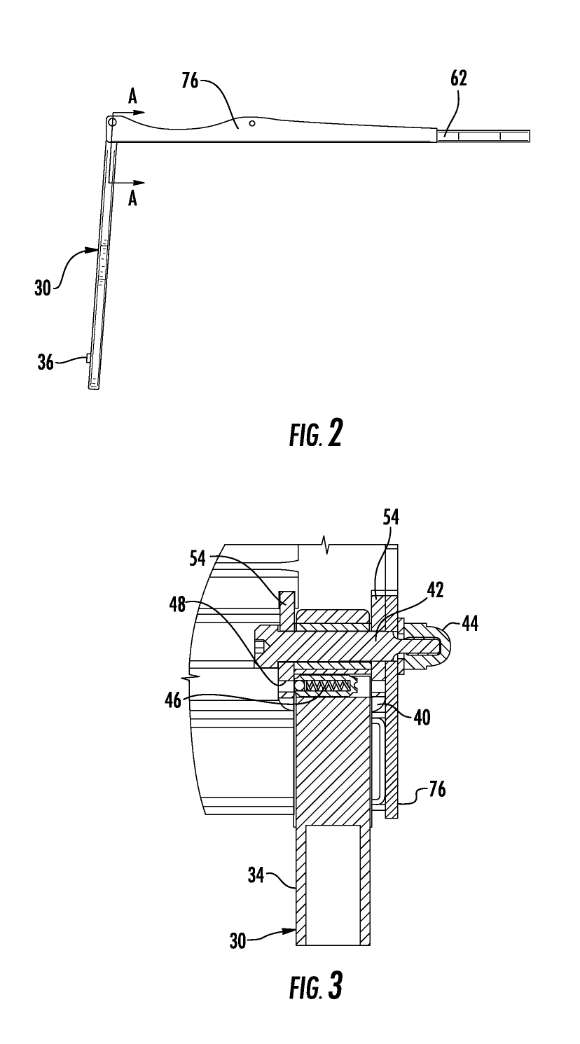

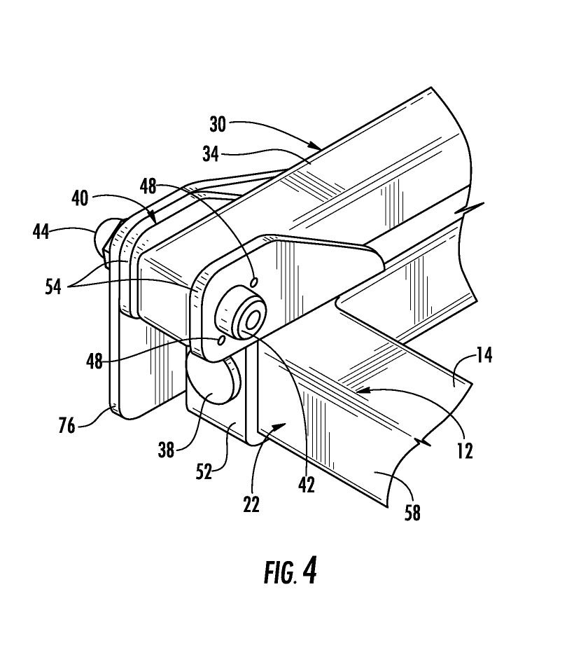

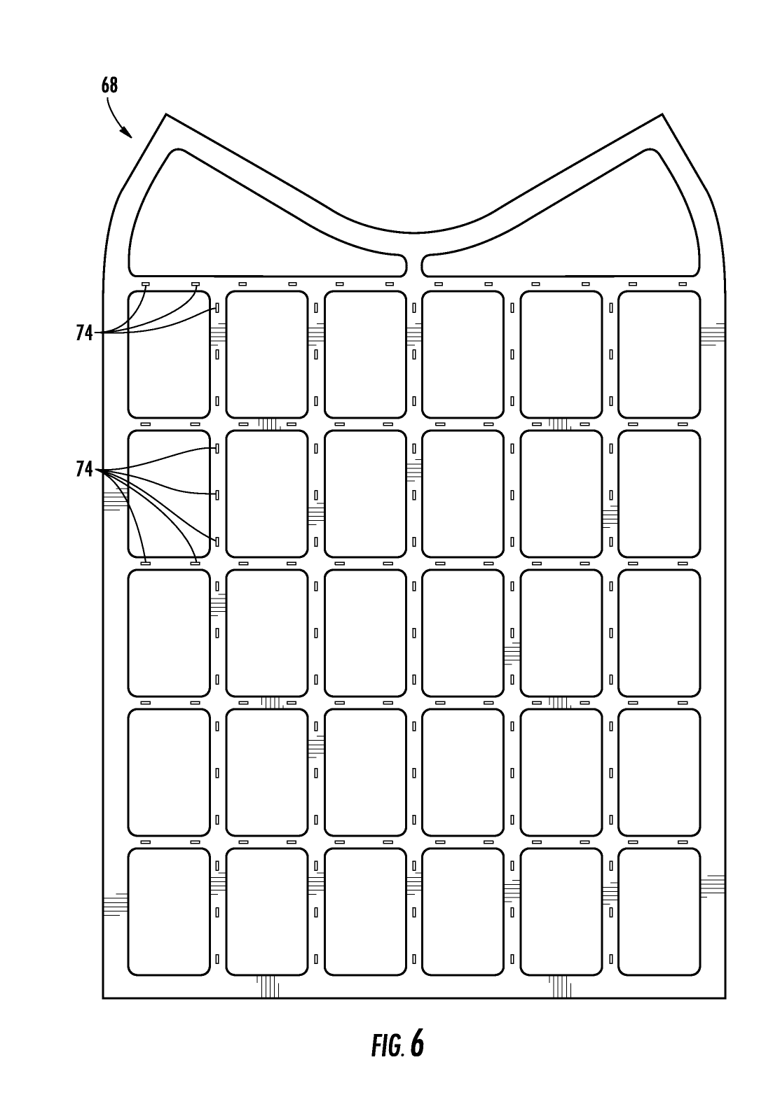

Referring now to FIGS. 1A, 1B and 2, the treestand platform with folding leg support of the present is shown generally at 10. The treestand platform 10 includes a platform 12 having top and bottom surfaces 14, 16, left and right sides 18, 20, and front and rear edges 22, 24. The rear edge 24 of the platform 12 has an arcuate surface 26 configured to contact a trunk of a tree. The rear edge 24 may be enhanced with teeth 28 (best seen in FIG. 5) to establish a better grip of the tree surface. Hingedly connected the front edge 22 of the treestand platform 10 is a folding leg support 30, which will be further described below. Alternatively, the folding leg support may also be connected to the left and right side 18, 20. The treestand platform 10 may then be configured for use as one of the four types of treestands described above by connecting accessory components, such as belt or chain to secure the platform to the trunk of the tree and toe holds for climbing treestands among others.

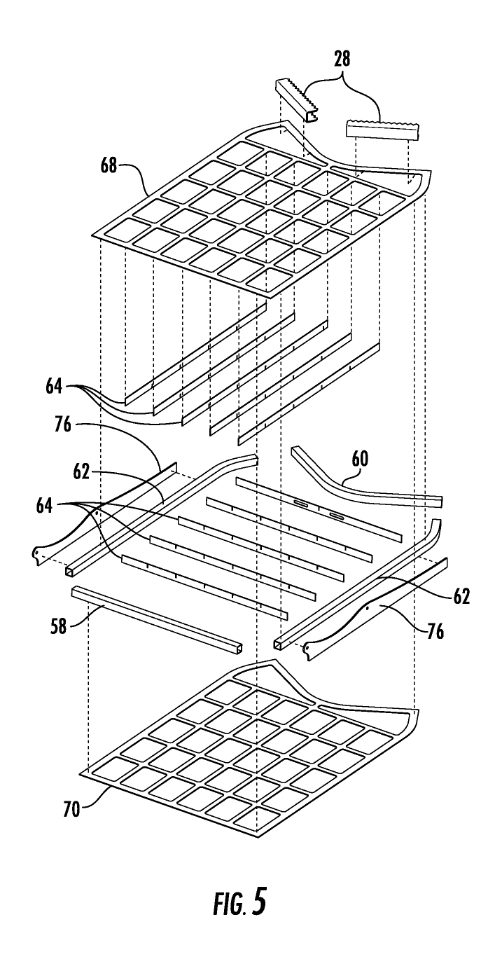

The folding leg support 30 includes a foot portion 32 and arm portions 34 extending from each end of the foot portion 32. The foot portion 32 may include grip tape on to enhance the surface traction of the foot portion 32 and prevent the hunter from slipping. The folding leg support 30 may include rubber bumpers 36 to prevent rattling of the leg support 30 against top surface 14 the platform 12 while the leg support 30 if folded closed. Referring to inset A and FIG. 4, rubber bumpers 38 on the front edge 22 of the platform 12 may also be included to prevent rattling of the leg support 30 against the platform 12 while the leg support 30 is deployed to the open position.

Referring to FIGS. 2-4, each arm portion 34 is secured to its own support bracket 40 by a shoulder screw 42 secured by an acorn lock nut 44. Each support bracket 40 is connected to the front edge 22 and respective side edge 18, 20 of the platform 12. Near the end of each support arm 34 of the leg support 30 are spring-biased ball plungers 46, which are used to selectively lock the leg support in its open of closed position as desired. Specifically, the ball plunger cooperates with apertures 48 formed in the support brackets 40, described further below.

Each support bracket 40 includes a body portion having a downwardly depending hook portion 52 to permit fastening of the support bracket 40 to the platform 12. Extending upwardly from the body portion is a pair of spaced-apart support structures 54 configured to receive the free ends of a support arm 34 therebetween. Each support structure 54 includes an aperture for receiving the shoulder screw 42 to retain the support arm 34 to the bracket 40. Also included is a pair of additional apertures 48 that are radially space-apart about the shoulder screw-receiving aperture and are sized to receive the spring-biased ball plunger 46. One aperture 48 is positioned to receive the spring-biased ball plunger 46 while the leg support 30 is in the deployed position, and the other aperture 48 is positioned to receive the ball plunger 46 while the leg support 30 is stowed upwardly against the top surface 14 of the treestand platform 12.

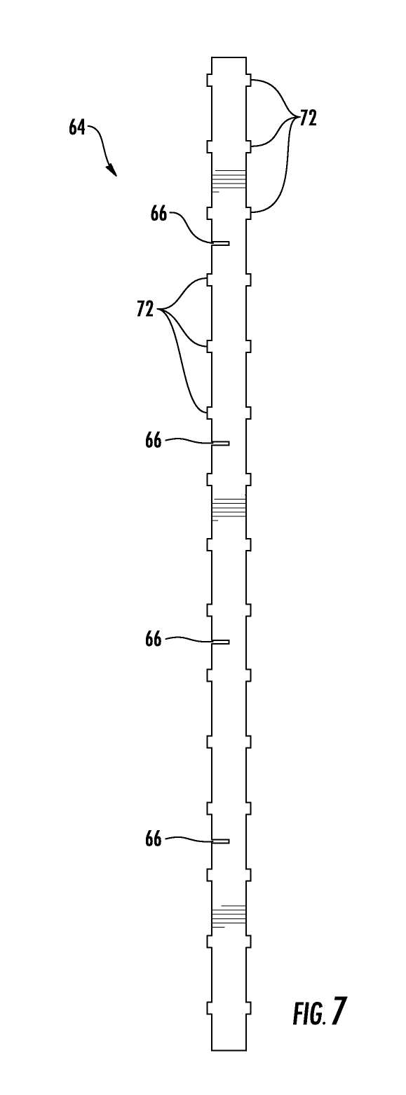

Referring to FIGS. 5-7, the treestand platform 12 is assembled from a number of separate components including a tubular frame having a front section 58, back section 60 and two side sections 62. Instead of tubular sections forming the frame, channeled sections may be used instead to further reduce the overall weight of the treestand platform 12. Within the space defined by the frame, a web is formed from a number of intersecting rail members 64 that include interfitting slot formations 66 to form a grid pattern. The grid pattern forms geometrically-shaped openings, such as rectangular, triangular, diamond and square openings, for instance. A top plate 68 and a bottom plate 70 enclose the frame and the internal web.

Each rail member 64 also includes a number of raised tabs 72 on the lower and upper edges that mate with slots 74 formed on the top and bottom plates 68, 70, respectively. The tabs 72 are configured to protrude through the slots 74 of the top plate 68 to provide a tread surface to prevent the hunter from slipping while standing on the treestand platform 12. During manufacturing, the tabs 72 protruding through the bottom plate 70 may be removed.

Attached to the left and right sides of the platform 12 and to the outside facing portion of the side sections 62 of the tubular frame are side rails 76, respectively. Each side rail 76 has an aperture that aligns with the shoulder screw-receiving aperture on the leg support brackets 40, which is best seen in FIG. 3. The shoulder screw 42 protrudes though the leg support bracket aperture and the aperture on the side rail 76. The acorn lock-nut 44 is received on the end of the shoulder screw 42.

After assembly of the platform 12, but prior to attaching the folding leg support 30, the treestand platform 12 is brazed to bond all of the components together. Dip brazing, furnace brazing, flame brazing may be used. Because all of the components are brazed together the treestand stand 10 will not creek or rattle when being carried or used by a hunter, thus preserving the hunter's stealth. The gird-like web structure formed out of the rail members 64 and the top plate 68 and bottom plate 70 forms an I-beam structure that has superior strength, yet is very lightweight. Using this technique, a treestand can be constructed that weighs as little as 4 lbs. yet hold up to 750 lbs., which surpasses the characteristics of prior art treestands.

Therefore, it can be seen that the treestand provides a unique solution to the problems of the prior art by providing a treestand platform that includes a grid-like web secured in a frame with a top and bottom plate that is brazed or adhered together. The combination of the grid-like web and top and bottom plates forms an I-beam structure that has superior strength over prior art treestands.

It would be appreciated by those skilled in the art that various changes and modifications can be made to the illustrated embodiments without departing from the spirit of the present invention. All such modifications and changes are intended to be within the scope of the present invention, except as limited by the appended claims.

What is claimed is:

1. A treestand platform, comprising:
a frame having a top surface and a bottom surface and interior portion;
a plurality of rail members configured and arranged to form a grid pattern with a top edge and bottom edge, said plurality of rail members secured within the interior portion of the frame;
a top plate secured the top surface of the frame and the top edge of the plurality of rail members; and
a bottom plate secured to the bottom surface of the frame and the bottom edge of the plurality of rail members.

2. The platform of claim 1, further comprising:
a left bracket and a right bracket secured to the frame; and
a leg support having a foot portion and an arm portion extending from the foot portion, each arm portion being pivotally connected to the left bracket and right bracket, respectively;
whereby said leg support is pivotally movable between a deployed position and a stowed position.

3. The platform of claim 2, wherein the leg support is selectively lockable in the stowed position and the deployed position.

4. The platform of claim 3, further comprising:
at least one surface defining an aperture through either one of the left bracket and the right bracket bracket; and
at least one spring-biased ball plunger connected to the arm portion of the leg support;
said spring-biased ball plunger being selectively engageable with said aperture to selectively lock the leg support in either one of the deployed position and the stowed position.

5. The platform of claim 1, further comprising a plurality of raised tabs extending upwardly from the top plate.

6. The platform of claim 1, further comprising a plurality of teeth extending rearward from the frame.

7. The platform of claim 1, wherein said grid pattern forms rectangular-shaped openings.

8. The platform of claim 4, wherein the aperture is a through-hole.

9. A treestand platform, comprising:
a frame having a top surface and a bottom surface and interior portion;
a plurality of rail members configured and arranged to form a grid pattern with a top edge and bottom edge, said plurality of rail members secured within the interior portion of the frame, said top edge and said bottom edge of said grid pattern having a plurality of raised tabs extending and depending therefrom, respectively;
a top plate secured the top surface of the frame and the top edge of the plurality of rail members, said top plate having a plurality of reciprocal slots configured and arranged to receive said plurality of raised tabs extending from said top edge of said grid pattern; and
a bottom plate secured to the bottom surface of the frame and the bottom edge of the plurality of rail members, said bottom plate having a plurality of reciprocal slots configured and arranged to receive said plurality of raised tabs depending from said bottom edge of said grid pattern.

10. The platform of claim 9, further comprising a leg support pivotally connected to said frame.

11. The platform of claim 9, further comprising a plurality of teeth extending rearward from the frame.

12. The platform of claim 1, wherein said grid pattern forms rectangular-shaped openings.

13. A treestand platform, comprising:
a frame having a top surface and a bottom surface and interior portion;
a plurality of teeth extending rearward from said frame;
a plurality of rail members configured and arranged to form a grid pattern having rectangular-shaped openings, said grid pattern having a top edge and bottom edge, said plurality of rail members secured within the interior portion of the frame, said top edge and said bottom edge of said grid pattern having a plurality of raised tabs extending and depending therefrom, respectively;
a top plate secured the top surface of the frame and the top edge of the plurality of rail members, said top plate having a plurality of reciprocal slots configured and arranged to receive said plurality of raised tabs extending from said top edge of said grid pattern;
a bottom plate secured to the bottom surface of the frame and the bottom edge of the plurality of rail members, said bottom plate having a plurality of reciprocal slots configured and arranged to receive said plurality of raised tabs depending from said bottom edge of said grid pattern; and
a leg support pivotally connected to said frame.

14. The platform of claim 13, wherein said leg support is selectively lockable in one of a deployed position and a stowed position.
